(19) United States
(12) Patent Application Publication
(10) Pub. No.: US 2025/0185620 A1
(43) Pub. Date: Jun. 12, 2025

(54) PROCESS OF OBTAINING CELLULOSE AND ACTIVATED CASSAVA FLOUR-BASED HYGIENIC PELLETS FOR ANIMALS AND PRODUCT OBTAINED

(71) Applicant: José Tadeu Dos Santos, Jaguariuna (BR)

(72) Inventor: José Tadeu Dos Santos, Jaguariuna (BR)

(21) Appl. No.: 18/740,171

(22) Filed: Jun. 11, 2024

(30) Foreign Application Priority Data
Dec. 7, 2023 (BR) 10 2023 025766 6

(51) Int. Cl. A01K 1/015

(52) U.S. Cl. CPC A01K 1/0155

(57) ABSTRACT

The present invention refers to hygienic or sanitary pellets for animals that combines high power of absorption and great bendability capacity, enabling the formation of firm clumps and the neutralization of odors, given that the liquid animal excrement is not accumulated in the recipients where the product is placed. Accordingly, it comprises a mixture of activated cassava flour-based pellets in its formulation, 30 and 50% of the total volume of the formulation, and of cellulose-based pellets, in a proportion between 50 and 70% of the total volume of the formulation.

### PRIORITY STATEMENT

This patent application claims the benefit and priority of Brazil Patent Application No. 10 2023 025766 6 filed to Brazil National Institute of Industrial Property on Dec. 7, 2023 and entitled as PROCESS OF OBTAINING CELLULOSE AND ACTIVATED CASSAVA FLOUR-BASED HYGIENIC PELLETS FOR ANIMALS AND PRODUCT OBTAINED, the disclosure of which is incorporated by reference herein in its entirety as part of the present application.

### BRIEF DESCRIPTION

This present application for patent of invention “PROCESS OF OBTAINING CELLULOSE AND ACTIVATED CASSAVA FLOUR-BASED HYGIENIC PELLETS FOR ANIMALS AND PRODUCT OBTAINED”, which refers to obtaining hygienic or sanitary pellets for animals comprising in its formulation cellulose and activated cassava flour-based pellets, providing a product that combines two characteristics of major interest: high power of absorption and major clumping capacity, enabling the formation of firm clumps and the neutralization of odors, given that the liquid present in the animal excrement is not accumulated in the recipients where the product is placed.

### FIELD OF APPLICATION

The present invention pertains to the sector of human needs, to the field of agriculture, more specifically, to the field of removal of animal excrement; because it refers to obtaining hygienic or sanitary pellets for animals comprising in its formulation a combination of cellulose and activated cassava flour-based pellets.

### Conviction

The sanitary/hygienic pellets or litter for animals are an essential item for whoever cares for a household cat. Besides being highly useful and practical, this type of product is fundamental for the hygiene and well-being of animals, for it enables pets to cover their feces and urine, generating a sensation similar to the one found in nature; and it facilitates the cleanliness of the ambient where animals live, given that it contributes to reduce odors from the excrement and facilitates the disposal thereof.

The use of the hygienic pellets, popularly known as “cat litter”, is quite straightforward: they are placed in litter boxes or litter trays, which are used instinctively by the animals, since they seek to eliminate odors that reveal their location, despite being protected in their homes, household cats manage to reproduce this natural behavior with the help of the hygienic pellets, contributing to their well-being.

Therefore, the cat litter is the substrate utilized in the litter box, its function being to absorb the urine and cover up the feces, eliminating odors and keeping the site constantly dry, clean and pleasant for the animals. Therefore, so that it can fulfill its function, tutors must replace it with a certain frequency.

Since this product is frequently handled by tutors and used by cats, it must be easy to use for both. In this sense, a lesser density is in the interest of tutors, given that the packets are large and the placement in a site with reduced size, as is the litter box, is hampered when the weight is rather heavy, and for the cats, who need to turn the pellets to bury their excrement. As the present invention combines activated cassava flour pellets and cellulose pellets in its composition, it has reduced density compared to bentonite, diatomite, wood and silica-based products.

Besides the reduced density, the pellets should have a high power of absorption and major clumping capacity, enabling the formation of firm clumps and the neutralization of odors, accordingly, the liquid present in the animal excrement is not accumulated in the recipients where the product is placed, which also contributes to stem the proliferation of micro-organisms.

In light of the foregoing, it is noted that the present invention contributes to solve problems pending in the technical field, by providing a product that combines the excellent absorption capacity of the cellulose with the high clumping capacity of the activated cassava flour, providing a product that associates these two fundamental characteristics in one efficient product.

### BACKGROUND OF THE INVENTION

Today, various options of sanitary/hygienic pellets or litter for animals are known. This type of product significantly facilitates the hygiene of the animal, in addition to cleaning the site by the tutors. Pellets are present on the market made of clay, wood, silica, wheat residue, sugarcane bagasse, diatomite among others.

Each of these products has its own particular features, for example, pellets made solely of cellulose; ordinary sand; clay; wood pellets; wheat residues; sugarcane bagasse and diatomite present high density; handling difficulty; high weight of the packages, albeit with the same volume of material; big dirt trail and they are not good binders, hindering the formation of clumps. Products made entirely of bentonite are good binders, however, do have good absorption, which enables the accumulation of liquid excrement in the recipients, generating the release of odors and proliferation of micro-organisms; additionally, these products have a production process that is more aggressive to the environment, as it requires the extraction of large quantities of minerals and cannot be discarded in toilet bowls.

The prior art BR102018072830A2, entitled “Process of obtaining hygienic/sanitary cellulose pellets for animal use and product thus obtained”, refers to a process of obtaining of hygienic/sanitary pellets made of virgin cellulose pulp and/or recovered from primary sludges from cellulose and paper factories, to be used in the breeding of cats and in captivity as well as in the breeding of small rodents in household environments or in commercial creations for various uses such as, for example, guinea pigs. In this sense, the process comprises the following steps:
1. Obtaining the cellulose pulp recovered from the primary sludge;
1a. Processing of the virgin cellulose pulp in hydra pulper;
1. Processing of the cellulose pulp in dewatering/extruder screw;
2a. Bleaching;
2. Treatment with biocide;
3. Classification;
4. Drying;
5. Functional coating of the granules;
6. Application of binding agents; and
7. Packaging.

It is important to point out that the product described in the prior art referred to is employed in the present invention, as both have a same inventor, given that it refers to hygienic or sanitary pellets for animals which comprises in its formulation: activated cassava flour-based pellets, obtained from a process with simple execution steps, in a proportion between 30 and 50% of the total volume of the formulation, and cellulose-based pellets, which is obtained according to the process described in document BR102018072830A2, in a proportion between 50 and 70% of the total volume of the formulation, in order to provide a product that combines two characteristics of major interest: high power of absorption and major clumping capacity, enabling the formation of firm clumps and the neutralization of odors, given that the liquid present in the animal excrement is not accumulated in the recipients where the product is placed.

The major technical advantage of the present invention in relation to the object of the prior art lies in providing a product that combines good bindability and absorption, differently to the clumps made up solely of cellulose, which despite having good absorbability, it does not have good bindability, not enabling the formation of firm clumps, which facilitate the hygienization of the recipient. Accordingly, the present invention represents an improvement of the prior art BR102018072830A2, not being anticipated thereby.

Prior art BR112016015161B1, entitled “Compositions of sanitary litter for animals, and manufacturing method thereof”, refers to the composition of a sanitary litter for animals that has a relatively low density (and, thus, lighter) and is partially composed of organic materials and, in the preferred embodiments, partially composed of inorganic materials, besides having other beneficial properties. Therefore, the document describes a composition comprising (i) a non-clumped particle, consisting essentially of organic material (for example, the organic material of the particle is not clumped or otherwise aggregated in a mass, or agglutinated with any other material), selected from the group consisting of particles of corncob, ground wheat, granules of almond shell and granules of pecan nut shell; and (ii) a coating in an outer surface of the particle, this coating comprises sodium bentonite. The prior art also describes an obtainment process comprising: (i) mixing non-clumped organic particles and a liquid to create wet organic particles; (ii) placing the wet organic particles into a blender; and (iii) adding bentonite sized in the range of 100 Mesh to 300 Mesh within the blender to coat the wet organic particles; and the addition of the bentonite is conducted for a period from 15 seconds to 2 minutes.

The prior art BR112020017470A2, entitled “Non-clay-based clumping sanitary litter for pets and methods of manufacturing and use of these sanitary litter for pets”, refers to non-clay-based clumping sanitary litter for pets, which may include mixing a material natural; compress the mixed natural material for forming pellets; grind the pellets to form granules; sieve the granules to obtain a pre-determined size range; and apply functional additives to the sized granules. The functional additives present in the product may include a binding agent, mineral oil and a surfactant, besides, additionally, a fragrance oil. The binding agent may be guar gum, and the surfactant may be a polysorbate. The material natural present may be one or more from among recycled paper, corrugated cardboard and sawdust. In another aspect, the non-clay-based clumping sanitary litter for pets contains granules of natural compacted material surrounded by a coating containing a binding agent, a mineral oil that adheres the binding agent to the granules and a surfactant.

The prior art BR102016026058A2, entitled “Pellets or coconut dust for coating and covering stalls, terrariums and pet sanitary litter” refers to pellets or coconut dust for coating and covering bays, terrariums and pet sanitary litter, obtained from an industrial technique for obtaining a coconut-derived material, coined from pellets or coconut dust, which, according to the technical specifications is utilized on beds for accommodating horses, cows, pigs, sheep, reptiles, poultry and pets. Given that the prior art comprises a different raw material to the present invention and that it does not suggest a composition made of cellulose-based pellets and activated cassava flour-based pellets.

The prior art BR0106609A, entitled “Powder product for sanitizing and binding sanitary litter and method of composition and maintenance of a bed of sanitary litter for cats”, refers to a product composed of a load of clay, bentonite, used in a suitable amount for maintaining the product in powder form, pursuant to the characteristics of the clay and which incorporated product destined for sanitizing per se; and the method comprising composition stage of the bed composed of the mixture of the litter and product and the maintenance; and after the cat has defecated and/or urinate in the bed and the sanitizing and binding powder product has bound the feces and/or urine and the litter, forming clumps composed of the product, litter and feces and/or urine, maintenance stage comprised by gathering up the clumps from between the remainder of the means constituting the bed and disposal of the clumps.

The prior art BR112020017470A2, entitled “Formulation for obtaining an odor-eliminating product, for mixing in sanitary litter”, refers to a formulation composed of benzalkonium chloride, extra-fine neutral alcohol, an odor blocker and Koralone®, homogenized in suitable volume percentages for obtaining an odor-blocking product, which is added to the sanitary litter used for the urine of household cats. There, the prior art does not anticipate the subject matter disclosed in the present invention.

### Objective of the Invention

The objective of the present invention is to provide hygienic or sanitary pellets for animals comprising in its formulation activated cassava flour-based pellets and cellulose-based pellets, providing a product that combines high power of absorption and great bindability capacity, enabling the formation of firm clumps and the neutralization of odors originating from the animal excrement.

### The Invention

The present invention refers to hygienic or sanitary pellets for animals comprising activated cassava flour-based pellets in its formulation, obtained from a process with simple execution steps, in a proportion between 30 and 50% of the total volume of the formulation, and cellulose-based pellets, which is obtained according to the process described in document BR102018072830A2, in a proportion between 50 and 70% of the total volume of the formulation, providing a product that combines two characteristics of major interest: high power of absorption and major clumping capacity, enabling the formation of firm clumps and the neutralization of odors, given that the liquid present in the animal excrement is not accumulated in the recipients where the product is placed.

### Advantages of the Invention

The main advantages of the present invention are:
Provides a product that combines high absorption power and great bindability capacity;
Provides a product of reduced density, that facilitates distribution logistics thereof, its placement, by the tutors, in the recipients and use by the pets;
Provides a totally biodegradable product, given that only cassava flour pellets and cellulose granules are present in its composition;
Provides a product whose obtainment process has lesser environmental impact, since it dispenses with mining minerals, given the absence of these components in the formulation, compared to the main competing products; and which uses a component produced from raw materials recovered from industrial waste.

### DESCRIPTION OF THE DRAWINGS

In order to facilitate the understanding of the present invention, references will be made to the figures described ahead:

FIG. 1: Flowchart of the process of obtaining the activated cassava flour-based pellets, present in the invention in a proportion between 30 and 50% of the total volume of the formulation;

FIG. 2: Flowchart of the process of obtaining the cellulose-based pellets present in the invention in a proportion between 50 and 70% of the total volume of the formulation.

### DETAILED DESCRIPTION OF THE INVENTION

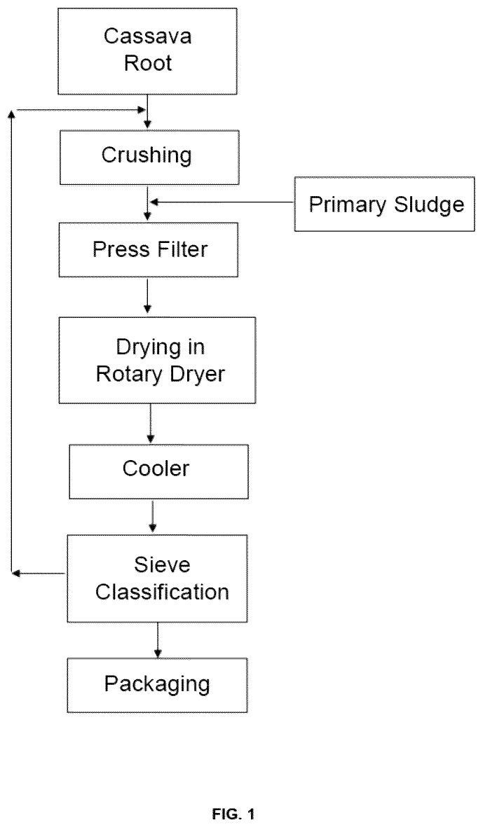

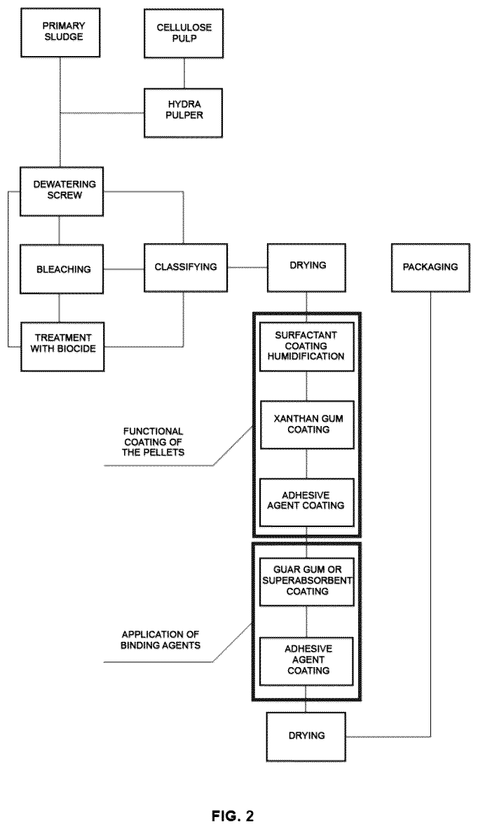

The process of obtaining the activated cassava flour and cellulose-based hygienic pellets for animals comprises: preparing the activated cassava flour-based pellets (FIG. 1) and mixing this granulate, at room temperature, in a proportion between 30 and 50% of the total volume of the formulation, with the cellulose-based pellets, in a proportion between 50 and 70% of the total volume of the formulation, which is previously prepared as a process claimed in document BR102018072830A2 (FIG. 2), and briefly described ahead.

The process of obtaining the activated cassava flour-based pellets (FIG. 1), present in the product in a proportion between 30 and 50% of the total volume of the formulation, comprises:
1. Grinding the cassava roots to obtain granules with 4-20 Mesh;
2. Mixing the cassava root granules with previously processed primary sludge.
3. Filtering and pressing the mixture of the cassava granules and primary sludge;
4. Drying the mixture of cassava granules and primary sludge in a rotary dryer, at a temperature of 35 to 250° C., for a variable period of time, with a view to obtaining granules with moisture content between 3% and 7%;
5. Classifying the mixture of granules in a manual, vibratory or rotary sieve with Mesh 4/20, the material withdrawn between the sieves being 4 and 20.
6. Obtaining activated cassava flour-based pellets, being ready to be mixed to the hygienic/sanitary cellulose pellets, obtained in parallel.

It is important to emphasize that the primary sludge refers to a material removed from rotary filters, dewatering presses or other devices, before entering into the waste treatment system, as a way of reducing the organic load in the treatment of industrial waste from the cellulose pulp and/or paper production units, comprised of 70% and 99% of fibers and between 1% and 30% of other components, such as kaolin, calcium carbonate, titanium dioxide, with moisture content between 90 and 99%).

For the pre-processing of primary sludge, the material is processed in a dewatering/extruder screw, with rotation between 2 and 30 rpm, for winding the fibrous material to form granules and reduce the moisture content to 60% to 90%; bleaching (optional step), in a mixer by sprinkling over the granules of solutions of hydrogen peroxide and/or sodium hypochlorite in loads that vary from 1 to 20 kg/t of granule, before the addition of hydrogen peroxide, sodium hydroxide can be added in an amount of 1 to 20 kg/t; and treatment with biocide, in a mixer, biocide agents, selected from among quaternary ammonium salts, halogenated styrenes, thiocyanates, carbamates and modified phenols applied by sprinkling over the mass of cellulose granules, in proportions varying from 50 to 5000 ppm of biocide considering the mass of cellulose granules.

The process of obtaining hygienic/sanitary cellulose pellets (FIG. 2), present in the product in a proportion between 50 and 70% of the total volume of the formulation, according to application BR102018072830A2, comprises the following steps:
1. Obtaining the cellulose pulp recovered from primary sludge:
   The cellulose pulp is recovered from primary sludge, a material withdrawn from rotary filters, dewatering screens, presses or other devices, before entering into the effluent treatment system, as a means to reduce the organic load in the treatment of industrial effluents of the cellulose pulp and/or paper production units;
   the material obtained in this step presents the form of mantle or particles and high moisture content (between 90 and 99%). The material in question, when dry, contains between 70% and 99% of fibers and between 1% and 30% of other components, such as kaolin, calcium carbonate, titanium dioxide among other potential components;
1. a. Processing of the virgin cellulose pulp in hydra pulper:
   When using virgin cellulose pulp, it must first be processed in a hydra pulper, with consistency varying between 0.1% and 4%; and then directed to the dewatering/extruder screw for producing cellulose pellets;
2. Processing of the cellulose pulp in dewatering/extruder screw;
   Viewing the formation of cellulose pulp granules, the material in question is processed in a dewatering/extruder screw, with rotation between 2 and 30 rpm. The rotation movement of the screw promotes the winding of the fibrous material leading to the formation of granules and additional reducing the moisture content to 60% to 90%;
2. a. Bleaching:
   This is an optional step, where hydrogen peroxide and/or sodium hypochlorite are added in loads that vary from 1 to 20 kg/t of granule;
   Additionally, before adding hydrogen peroxide, sodium hydroxide can be added in an amount of 1 to 20 kg/t;
   This step can be carried out in rotary mixing equipment of the concrete mixer or rotary cylinder type. The addition of the chemical agents is carried out by sprinkling solutions with known concentrations over the granules;
3. Treatment with biocide:
   After the formation of the granules or after the optional step of bleaching, the granules are treated with biocides with a view to eliminating potential colonies of undesirable micro-organisms. Accordingly, the granules are processed in a rotary mixer (batch) or rotary cylinder (continuous), the biocide agents being applied by sprinkling on the mass of cellulose granules in proportions varying from 50 to 5000 ppm of biocide considering the mass of cellulose granules;
   Among the main biocide agents that can be used in this step of the process are: quaternary ammonium salts, halogenated styrenes, thiocyanates, carbamates and modified phenols (sodium benzoate, among others);
4. Classification:
   The granules are classified in a manual, vibratory or rotary sieve, with a Mesh 4/20, the material being withdrawn between sieves 4 and 20 destined for application as hygienic/sanitary pellets for use with pets (cats). In some cases, it is also possible to use sieves with an opening of 6/60 Mesh;
5. Drying:
   Drying can be carried out at ambient temperature for a period of 7 to 15 days with periodic turning every 12 or 24 hours; or in static fluidized bed driers, or rotary driers/ovens; in this equipment, the operating temperature varies from 35 to 250° C., for a variable period of time, with a view to obtaining granules having a moisture content between 3% and 7%.
6. Functional coating of the granules:
   The purpose of the functional coating of the granules is to add thereto the potentiality to form agglomerates (“clumps”) when exposed to moisture (animal urine), increase the liquid retention capacity as well as the odor retention capacity. With a view to increasing their liquid absorption capacity, the granules are treated with surfactants. This treatment with surfactants is carried out by sprinkling the surfactant in aqueous solution over the cellulose granules;
   The granules are placed in a batch mixer (concrete type) or drum mixer (continuous) with a rotation between 10 and 50 rpm;
   Non-lonics, cationic or anionic surfactants are used, with a dosage between 0.05 and 0.5% of dry granule mass base;
   The volume of the surfactant solution to be sprinkled over the granules should correspond to the level of moisture of 1 to 5% of the granule mass (dry base);
   After humidifying the granules with surfactant solution spray, for the period of 10 to 20 seconds, the powder xanthan gum, with grain size between 80 and 200 Mesh should be pulverized over the moistened mass of pellets. The amount of xanthan gum to be applied may vary from 0.02% to 4% of dry granule mass base to be coated;
   The coating is repeated, where the granules must again be moistened with water spray, as already described previously. In this step, the water mass used for humidification should be equivalent to 0.2 to 2.0% of the dry mass (equivalent) of granules;
   It is possible to use adhesive agents in substitution of water such as carboxymethylcellulose (CMC), polyvinyl alcohol, cassava starch, xanthan gum, guar gum and derivatives-in the case of these agents, the load may vary from 0.001% to 0.2% based on the dry mass of pellets. The concentration of the aqueous solution of adhesive agents may vary from 2 to 50 g/L such that it can be sprayed over the granules;
   When opting not to apply a surfactant, the granules should be moistened by sprinkling water and/or polyvinyl alcohol so as to allow adhesion of the binding agent on the surfaces of the granules (coating);
7. Application of binding agents:
   After applying the spray of water or adhesive agent on the granules, the guar gum is sprayed over the cellulose granules. The particle size of the guar gum power must be below a 200 Mesh. The amount of guar gum applied should be from 0.2 to 5% in mass based on the dry mass equivalent of the cellulose granules;
   Alternatively to coating with guar gum, absorbent agents such as sodium polyacrylates can be used, in the same proportions as the guar gum;
   After applying the guar gum coating, the granules can be given a fresh application of adhesive agent as described previously;
   Checking the moisture content, where after all the coating process, the maximum water mass applied must not take the moisture content of the coated granules to amounts exceeding 10%;
   Should the moisture of the coated material exceed this limit, the granules should be submitted to a new drying process.

After obtaining the hygienic/sanitary cellulose pellets, the component is ready to be mixed to the activated cassava flour-based pellets, obtained parallel.

Lastly, in order to obtain the activated cassava flour and cellulose-based pellets, the previously prepared pellets are mixed, at ambient temperature, and packaged (in plastic or paper bags, boxes or big bags), respecting the proportion of 30 and 50% of the total volume of the formulation of activated cassava flour-based pellets and, between 50 and 70% of the total volume of the formulation, of cellulose-based pellets.

Accordingly, the composition of the activated cassava flour and cellulose flour-based pellets comprises:
Activated cassava flour-based pellets, in a proportion between 30 and 50% of the total volume of the formulation; and
Cellulose-based pellets, in a proportion between 50 and 70% of the total volume of the formulation.

1. An activated cassava flour and cellulose-based hygienic pellet formulation, comprising:
a mixture of:
activated cassava flour-based pellets, in a proportion between 30% and 50% of the total volume of the formulation; and
cellulose-based pellets, in a proportion between 50% and 70% of the total volume of the formulation.

2. The activated cassava flour and cellulose-based hygienic pellet formulation according to claim 1, wherein a cellulose pulp for the cellulose-based pellets is recovered from a primary sludge comprised of 70% to 99% of fibers and, between 1% and 30% of non-fiber components, with moisture content between 90% and 99%.

3. A method for an activated cassava flour and cellulose-based hygienic pellet formulation, comprising:
grinding cassava roots to obtain cassava granules with 4-20 Mesh;
mixing, at ambient temperature, the cassava granules with a previously processed primary sludge;
filtering and pressing the mixture of the cassava granules and primary sludge;
drying the mixture of the cassava granules and primary sludge in a rotary dryer, at a temperature of 35° C. to 250° C., for a variable period of time, until obtaining a moisture content between 3% and 7% for the mixture;
classifying the mixture in a manual, vibratory or rotary sieve with a Mesh 4/20, the mixture being retained between sieves 4 and 20;
obtaining ready activated cassava flour-based granules from the mixture;
mixing, at ambient temperature, the activated cassava flour-based granules, at a proportion between 30% and 50% of the total volume of the formulation, to previously obtained cellulose-based pellets, in a proportion between 50% and 70% of the total volume of the formulation.
